(19) United States
(12) Patent Application Publication
(10) Pub. No.: US 2006/0119570 A1
(43) Pub. Date: Jun. 8, 2006

(54) Switch and method of combining multiple switch functions into a single switch

(76) Inventors: Gary M. Searle, Norfolk, MA (US); Andrew Crombie, Berkley, MA (US)

Correspondence Address: GROSSMAN, TUCKER, PERREAULT & PFLEGER, PLLC, 55 SOUTH COMMERICAL STREET, MANCHESTER, NH, 03101, US

(21) Appl. No.: 11/158,337

(22) Filed: Jun. 21, 2005

Related U.S. Application Data
(60) Provisional application No. 60/581,590, filed on Jun. 21, 2004.

(51) Int. Cl. G09G 5/00

(52) U.S. Cl. 345/156

(57) ABSTRACT

A switch and a method of combining multiple switch functions into a single switch. A selector switch is provided for selecting functionality for each of a plurality of additional switches.

### CROSS-REFERENCE TO RELATED APPLICATIONS

This application claims the benefit of co-pending U.S. Provisional Patent Application Ser. No. 60/581,590 filed on Jun. 21, 2004 the teachings of which are fully incorporated herein by reference.

### TECHNICAL FIELD

The present invention relates generally to electrical switches, and, more particularly to a switch and method of combining multiple switch functions into a single switch.

### BACKGROUND

Automotive manufacturers continue to provide additional features and functions for the consumer as vehicle styling and passenger comfort evolves. Novel vehicle functions that have recently been incorporated into the instrument panel include, traction control, passenger air bag disable, rear parking alarm, interactive vehicle dynamics, and automatic traction and stability. Depending on the scope of the function, a single or multiple-gang switch is added to the instrument panel. Each required switch adds cost and manufacturing time to a vehicle, and can consume significant space on an instrument panel.

There is, therefore, a need for a system and method for combining multiple switch functions into a single switch.

### BRIEF DESCRIPTION OF THE DRAWINGS

Advantages of the present invention will be better understood by reading the following detailed description, following figures wherein like numerals represent like parts.

FIGS. 1A and 1B illustrate the top surface of two typical three-button switches, a message center (MC) and a four-wheel drive (4 ×4), respectively.

FIG. 1C illustrates the top surface of a single four-button switch that is a combination of the two three-button switches shown in FIGS. 1A and 1B.

FIG. 2A is an electrical block diagram of an exemplary message center switch.

FIG. 2B is an electrical block diagram of an exemplary 4×4 switch.

FIG. 2C is an electrical block diagram of the combined switches, corresponding to the four-button switch shown in FIG. 1C.

FIG. 2D is an exemplary LIN technology embodiment of the configuration shown in FIG. 2C.

FIGS. 3A, 3B, and 3C illustrate cosmetic surfaces that correspond with the LCD outputs that would occur as the fourth button is scrolled from MC to 4×4 to RPA/TC/PAB, respectively.

### DETAILED DESCRIPTION

For ease of explanation, the exemplary embodiments described herein utilize push button actuation. Features of the present disclosure may, however, be used in connection with a wide variety of switch types. For example, the switch actuation can be linear, as in the case of a push button or slider, or rotary, as in the case of a rocker button or rotary knob. It is to be understood, therefore, that illustrated exemplary embodiments described herein are provided only by way of illustration, and are not intended to be limiting.

Combining multiple switch functions into a single switch in a manner consistent with the present invention provides cost savings by (1) reducing the ratio of switch components to switch function, (2) reducing assembly cost as a result of having fewer components, and (3) reducing the physical wiring and connectors in the vehicle and instrument panel.

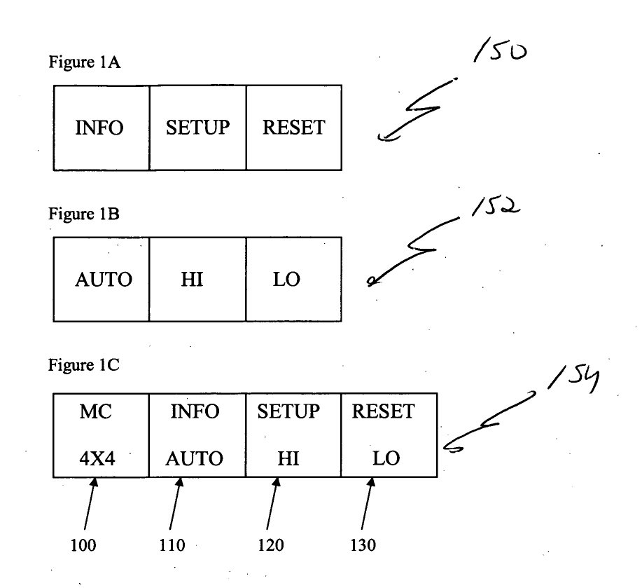

One embodiment for combining multiple switch functions into a single switch includes adding another actuator to the switch assembly for the purpose of toggling the functions of the remaining buttons. One example of this approach is shown in FIGS. 1A, 1B, and 1C. FIGS. 1A and 1B show the cosmetic surface of two typical three-button switches, a message center (MC) 150 and a four-wheel drive (4×4) 152 respectively. FIG. 1C shows the cosmetic surface of a single four-button switch 154 that is a combination of the two three-button switches shown in FIGS. 1A and 1B. The fourth button 100 may allow the operator to toggle between the MC and 4×4 functions. The remaining three buttons may only provide one set of functions depending on the state of the fourth button. In other words, if the remaining three buttons 110, 120, and 130 are in the INFO, SETUP, and RESET modes respectively, actuating the MC/4×4 button (100) will change the output functions of the remaining three buttons (110, 120, and 130) to AUTO, HI, and LO, respectively.

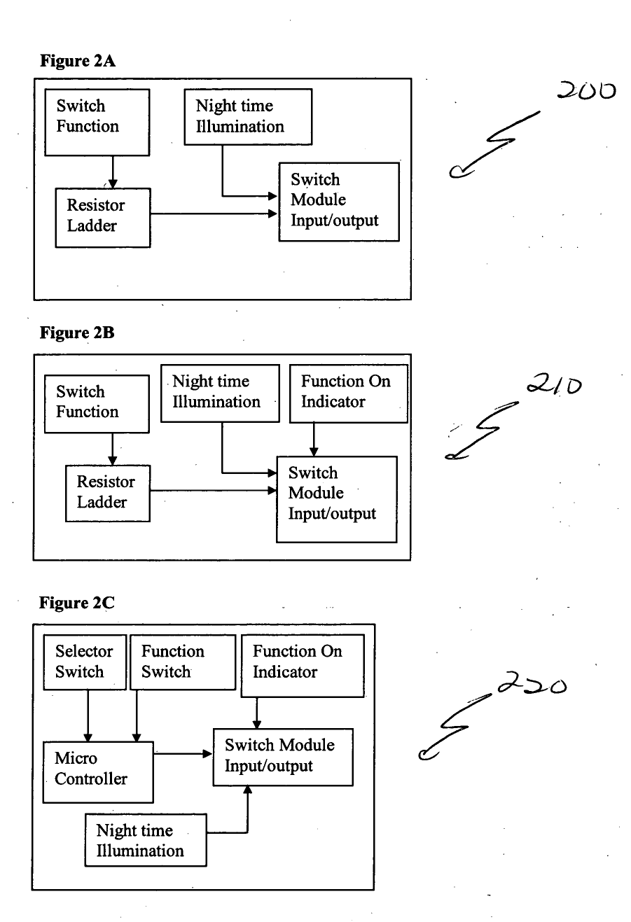

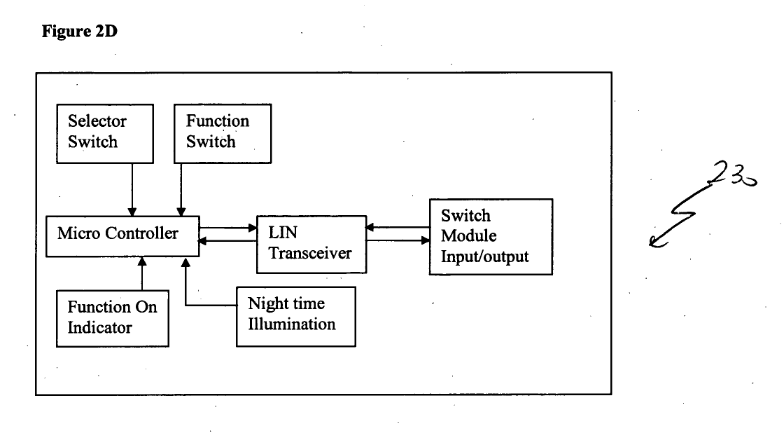

FIG. 2A is an electrical block diagram an exemplary message center switch, and FIG. 2B is an electrical block diagram of an exemplary 4×4 switch 210, which corresponds to FIGS. 1A and 1B respectively. FIG. 2C is an electrical block diagram of the combined switches 220, corresponding to the four-button switch shown in FIG. 1C. The electrical portion of the switch may be a low current contact closure that when closed either completes a 12-volt circuit or provides a millivolt output to the control module in the vehicle. The control module may directly switch the current to actuate the intended switch function.

To meet the illumination requirements of the automotive industry, the fourth button (100) may be lit by a light emitting diode (LED) or incandescent lamp to meet a daytime bright standard which is approximately two to four times as bright as nighttime illumination. Only one of the graphics on the fourth button may be lit at one time, and the lit graphic may identify the functions of the remaining three buttons that are enabled. The remaining three buttons may be lit by LEDs or incandescent lamps to meet a nighttime illumination standard. The illumination for these buttons may be connected to the headlamp function so that the illumination can be adjusted or dimmed with the rest of the instrument panel. The toggle function may be accomplished electrically within the programming of the microprocessor. The output functions of the remaining three buttons may also be toggled between their respective two outputs by the microprocessor.

The electrical architecture of automotive vehicles has been slowly evolving from a complex relay network to a programmable network utilizing Controller Area Network (CAN) and Local Interconnect Network (LIN) technology. CAN is a known network protocol that has been developed for automotive applications. CAN provides a standardized communication protocol where the communication burden has been shifted from the host central processing unit (CPU) to intelligent nodes, i.e. microprocessors. CAN reduces wiring harness size and point to point wiring, thereby reducing the overall cost for the electrical system of the vehicle. LIN is a known low cost, master-slave protocol utilizing serial communication through a single wire referenced to a 12-volt battery. The LIN bus is a connection between the electrical actuators and the Electronic Control Unit (ECU), which is often a gateway with CAN bus. The electrical block diagram in FIG. 2C could be replaced by LIN technology, as shown, for example, in the embodiment 230 of FIG. 2D. Both of the block diagrams shown in FIGS. 2C and 2D provide the ability to toggle the functions of the remaining three buttons. As previously stated, the LIN circuitry requires less input/output terminals, because LIN utilizes serial communication.

The LIN block diagram shown in FIG. 2D could be further modified to incorporate additional functions for the remaining three buttons. For this alternative, the fourth button would allow the operator to scroll through a series of function sets for the remaining three buttons. The electrical block diagram used in FIG. 2D is also applicable to this four-button switch alternative, and the microprocessor program would be modified to include the functions of rear parking alarm (RPA), traction control (TC), and passenger air bag (PAB).

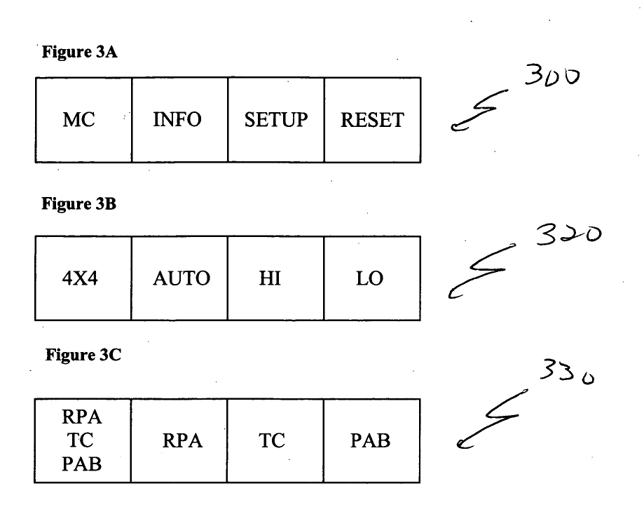

Using LIN technology, the functionality of the four-button switch may be greatly expanded. However, scrolling through the functional hierarchy could be confusing for the operator. To enhance the user friendliness of this alternative, the switch could be modified by; (1) Incorporating liquid crystal displays (LCDs) into the cosmetic surface of the buttons. The program in the microprocessor would be expanded for the added functions, and the LCD would display only the graphic or text that corresponds with the enabled function. FIGS. 3A, 3B, and 3C are the cosmetic surfaces 300, 320, 330 that correspond with the LCD outputs that would occur as the fourth button is scrolled from MC to 4×4 to RPA/TC/PAB respectively. (2) Incorporating audio feedback into the switch could further enhance operation of the expanded four-button switch. This feature could be accomplished by using a piezo-electric device or audio transmitter.

There is thus provided a switch a method of combining multiple switch functions into a single switch, to thereby reduce the overall cost per switch function in a vehicle. The switch and method described herein may incorporate Local Interconnect Network (LIN) microprocessors. The cost of adding LIN to the switch is within the savings derived by combining switch functions. Embodiments of a switch and method consistent with the invention may allow one or more of several advantages, including, but not limited to:
(1) Combining the functions of two three-button switches into a single four-button switch and using a microprocessor to control and enable the output functions.
(2) Using the fouth button as a toggle button to select different output functions from the remaining three buttons. Toggle implying that only two sets of output functions are controlled.
(3) Combining the functions of two or more three-button switches into a single four-button switch and using a microprocessor with LIN to control and enable the output functions.
(4) Using the fouth button as a scroll button to select different output functions from the remaining three buttons. Scroll implying that more than two sets of output functions are controlled.
(5) The use of LCDs and a microprocessor to provide programmable text or graphics on the cosmetic surface of the switch.
(6) The use of a piezo electric device or an audio transmitter in combination with a microprocessor to provide programmable audio signal that corresponds to the output function.
(7) The combination of (5) and (6) in the same switch assembly.

While the principles of the invention have been described herein, it is to be understood by those skilled in the art that this description is made only by way of example and not as a limitation as to the scope of the invention. Other embodiments are contemplated within the scope of the present invention in addition to the exemplary embodiments shown and described herein. Modifications and substitutions by one of ordinary skill in the art are considered to be within the scope of the present invention, which is not to be limited except by the following claims.

What is claimed is:

1. A switch comprising:
a plurality of user-actuatable switch buttons, at least one of said buttons being a selector switch for controlling functionality associated with a remainder of said switch buttons, whereby in each of a plurality of different states of said selector switch each of said remainder of said buttons has a different associated functionality.

2. A switch according to claim 1, wherein at least one of said switch buttons is coupled to a Local Interconnect Network (LIN) of a vehicle.

3. A switch according to claim 1, wherein at least one of said switch buttons is coupled to a Controller Area Network (CAN) of a vehicle.

4. A switch according to claim 1, wherein said at least one of said switch buttons is coupled to an audio device configured to provide an audible indication associated with each of said states.

5. A vehicle switch network comprising:
a vehicle communication network;
a switch coupled to said network, said switch comprising a plurality of user-actuatable switch buttons, at least one of said buttons being a selector switch for controlling a vehicle system function associated with each a remainder of said switch buttons, whereby in each of a plurality of different states of said selector switch each of said remainder of said buttons has a different associated vehicle system function.

6. A network according to claim 5, wherein said communication network comprises a Local Interconnect Network (LIN).

7. A network according to claim 5, wherein said communication network comprises a Controller Area Network (CAN).

8. A network according to claim 5, wherein said at least one of said switch buttons is coupled to an audio device configured to provide an audible indication associated with each of said states.

9. A method of combining multiple switch functions into a single switch:
providing a switch comprising a plurality of user-actuatable switch buttons, at least one of said buttons being a selector switch for controlling a vehicle system function associated with each a remainder of said switch buttons, whereby in each of a plurality of different states of said selector switch each of said remainder of said buttons has a different associated vehicle system function.
